(19) United States
(12) Patent Application Publication
(10) Pub. No.: US 2018/0095552 A1
(43) Pub. Date: Apr. 5, 2018

(54) REMOTE CONTROL DEVICE FOR DISPLAY SCREEN AND METHOD FOR REMOTELY CONTROLLING DISPLAY SCREEN

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Kun LI, Beijing (CN); Shancai ZHANG, Beijing (CN); Yueyuan ZHANG, Beijing (CN); Yuting YANG, Beijing (CN); Tao MA, Beijing (CN)

(21) Appl. No.: 15/519,932

(22) PCT Filed: Sep. 30, 2016
(86) PCT No.: PCT/CN2016/101036

§ 371 Date: Apr. 18, 2017

(30) Foreign Application Priority Data
Jan. 4, 2016 (CN) 201610003716.6

(51) Int. Cl. G06F 3/0354; H04N 21/41

(52) U.S. Cl. CPC G06F 3/03542; H04N 21/4126; G06F 3/03545

(57) ABSTRACT

The example embodiments of the present disclosure relate to a remote control device for a display screen and a method for remotely controlling a display screen. The remote control device comprises at least three distance sensor receivers that are fixed with respect to the display screen and arranged at different positions, a control pen and a control point recognition unit, wherein the control pen is provided with at least two distance sensor transmitters at positions in different distances to a pen tip; the at least three distance sensor receivers are configured to receive ranging signals from the at least two distance sensor transmitters, respectively; the control point recognition unit is configured to determine a control point of the control pen on the display screen based on the ranging signals received by the at least three distance sensor receivers. According to the example embodiments of the present disclosure, a control of the display screen is no longer limited by the distance, while the control pen is not contacted with the display screen directly to avoid the display screen from being scraped.

### CROSS-REFERENCE TO RELATED APPLICATION

This application claims the benefit and priority of Chinese Patent Application No. 201610003716.6, filed on Jan. 4, 2016, the disclosures of which are incorporated by reference herein in their entirety as part of the present application.

### Field

The example embodiments of the present disclosure relate to a remote control device for a display screen and method for remotely controlling the display screen.

### Background

The section is intended to introduce to the readers various technologies in this field which may be relevant to various aspects of the present application. It is believed that the section will be helpful to provide the readers with background information to better understand various aspects of the present application. Therefore, it shall be appreciated that the section is construed from this perspective, rather than being deemed as an acknowledgement of prior art.

The conventional touch screen technologies employ a contact-type touch control by a finger or a stylus, which are severely limited by the distance. In addition, the finger or stylus can easily scratch the touch screen, thereby speeding up the touch screen aging. At present stage, the touch control function is generally realized in a resistive or capacitive touch control principle, usually for a touch screen with a small size, wherein the resistive touch control principle is the use of a pressure induction: when the finger touches the screen, two conducting layers are contacted with each other at the touch point, and the resistance is changed to generate signals in directions X and Y which are then sent to a touch screen controller. The capacitive touch control principle works through a current induction of the human body: the surface of the capacitive screen is coated with a transparent conducting layer, the voltage is connected to the four corners, and the tiny direct current is distributed on the screen surface to form a uniform electric field; when a contact is made with a finger, the human body acts as one pole of a coupling capacitor, while the current is collected from the four corners of the screen to form the other pole of the coupling capacitor, and a relative distance for conducing the current to the touch position is calculated by the controller to obtain the touch coordinates.

The above touch controls are all of a contact-type, and an operating apparatus capable of long-distance control is emergently required on many occasions. The long-distance control (remote control) is widely applied on various meeting-demonstration occasions.

### SUMMARY

A remote control device and a method for remotely controlling the display screen according to the example embodiments of the present disclosure enable a control of the display screen is no longer limited by the distance, while the control pen is not contacted with the display screen directly to avoid the display screen from being scraped, thus the service life of the display screen can be prolonged. In particular, this is more prominent in the applications of teaching, demonstration and meeting, so that the user's usage of the display screen is more free and relaxed, and the user's operation experience is improved.

According to one aspect of the present disclosure, there is provided a remote control device for a display screen. The remote control device may comprise at least three distance sensor receivers that are fixed with respect to the display screen and arranged at different positions, a control pen and a control point recognition unit, wherein the control pen may be provided with at least two distance sensor transmitters at positions in different distances to a pen tip; the at least three distance sensor receivers may be configured to receive ranging signals from the at least two distance sensor transmitters, respectively; the control point recognition unit may be configured to determine a control point of the control pen on the display screen based on the ranging signals received by the at least three distance sensor receivers.

According to an example embodiment of the present disclosure, the control point recognition unit may be further configured to acquire position coordinates of the at least two distance sensor transmitters with respect to the display screen based on the ranging signals, acquire an intersection between a straight line along which the control pen is arranged and the display screen based on the position coordinates, and determine a control point of the control pen on the display screen.

According to an example embodiment of the present disclosure, the ranging signal may be at least one of an infrared signal and an ultrasonic signal.

According to an example embodiment of the present disclosure, the remote control device for the display screen may further comprise a display screen control unit, wherein the control pen may further comprise a control pen main control unit configured to generate a control command signal; the display screen control unit may be configured to receive the control command signal from the control pen main control unit in a wire or wireless manner, so as to perform an operation corresponding to the control command signal on respective content in the display screen.

According to an example embodiment of the present disclosure, the control pen may further comprise a control pen command receiving unit; the control pen main control unit may be further configured to generate the control command signal based on a control command received by the control pen command receiving unit.

According to an example embodiment of the present disclosure, the control pen command receiving unit may be a pressure sensor.

According to an example embodiment of the present disclosure, the display screen may be a touch screen.

According to an example embodiment of the present disclosure, the control pen may be provided with a laser transmitter configured to indicate a position of the control point.

According to an example embodiment of the present disclosure, the control pen may be further provided with a laser transmitter switch configured to control On-Off of the laser transmitter.

According to an example embodiment of the present disclosure, the control pen may be further provided with a control pen switch configured to control On-Off of the distance sensor transmitter.

According to an example embodiment of the present disclosure, the at least three distance sensor receivers may comprise three distance sensor receivers arranged at different corners of the display screen.

According to another aspect of the present disclosure, there is further provided a method for remotely controlling a display screen. The method comprises: receiving ranging signals from at least two distance sensor transmitters on a control pen and at positions in different distances to a pen tip, respectively, by at least three distance sensor receivers fixed with respect to the display screen and arranged at different positions; and determining a control point of the control pen on the display screen, based on the ranging signals received by the at least three distance sensor receivers.

According to an example embodiment of the present disclosure, the method for remotely controlling the display screen may further comprise determining whether the determined control point locates within an effective area of the display screen; in response to that the determined control point locates within the effective area of the display screen, determining that the determined control point is effective and analyzing a control command signal received from the control pen so as to perform an operation corresponding to the control command signal on respective content in the display screen; in response to that the determined control point does not locate within the effective area of the display screen, determining that the determined control point and the control command signal are ineffective.

According to an example embodiment of the present disclosure, determining the control point of the control pen on the display screen may comprise: acquiring position coordinates of the at least two distance sensor transmitters with respect to the display screen, acquiring an intersection between a straight line along which the control pen is arranged and the display screen based on the position coordinates, and determining the control point of the control pen on the display screen.

According to an example embodiment of the present disclosure, the ranging signal may be at least one of an infrared signal and an ultrasonic signal.

According to an example embodiment of the present disclosure, the display screen may be a touch screen.

According to an example embodiment of the present disclosure, the method for remotely controlling the display screen may further comprise indicating a position of the control point by a laser transmitter on the control pen.

According to an example embodiment of the present disclosure, the control command signal may be generated by the control pen based on a control command received by the command receiving unit.

### DRAWINGS

In order to more clearly illustrate the technical solutions in the embodiments of the present disclosure, the drawings of the embodiments will be briefly described as follows. Obviously, the following drawings just relate to some embodiments of the present disclosure, rather than limitations to the present disclosure.

FIG. 1 shows a structure diagram of a remote control device according to an example embodiment of the present disclosure;

FIG. 2 shows a structure diagram of a control pen according to an example embodiment of the present disclosure;

FIG. 3 shows a flowchart of a method for remote control according to an example embodiment of the present disclosure;

FIG. 4 shows a schematic diagram of signal transmission between a control pen main control unit and a display screen control unit according to an example embodiment of the present disclosure.

### DETAILED DESCRIPTION

In order that the objectives, technical solutions and advantages of the embodiments of the present disclosure are clearer, the technical solutions in the embodiments of the present disclosure will be clearly and completely described as follows in conjunction with the drawings of the embodiments of the present disclosure. Obviously, those described are just a part of the embodiments of the present disclosure rather than all of the embodiments. Based on the embodiments of the present disclosure, any other embodiment obtained by a person skilled in the art without paying any creative effort shall fall within the protection scope of the present disclosure.

To be noted, in the descriptions of the present disclosure, the orientations or positional relations indicated by the terms “on/above”, “under/below”, “top”, “bottom”, etc. are those illustrated based on the drawings. They are just used to facilitate or simplify the descriptions of the present disclosure, rather than indicating or implying that any mentioned device or element must have a particular orientation, or be constructed or operated in a particular orientation, and hence cannot be construed as limitations to the present disclosure.

In addition, in the descriptions of the present disclosure, “a plurality of” means “two or more”, unless otherwise specified.

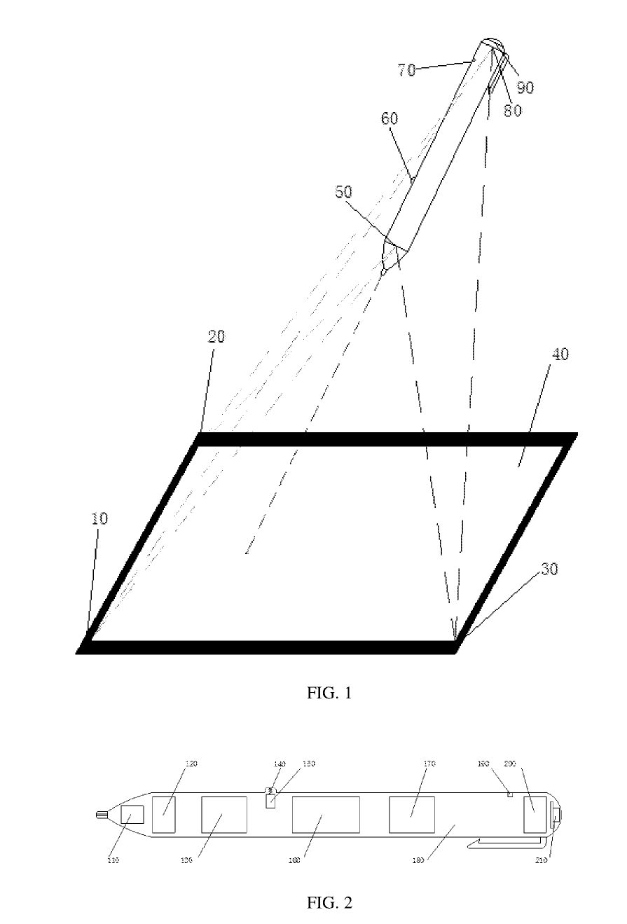

As illustrated in FIG. 1, according to an example embodiment of the present disclosure, a remote control device for a display screen 40 is provided. The remote control device comprises at least three distance sensor receivers 10, 20 and 30 that are fixed with respect to the display screen 40 and arranged at different positions, a control pen and a control point recognition unit, wherein the control pen is provided with at least two distance sensor transmitters 50 and 80 at positions in different distances to a pen tip; the control point recognition unit is configured to determine a control point of the control pen on the display screen 40 based on ranging signals received by the at least three distance sensor receivers 10, 20 and 30 from the at least two distance sensor transmitters 50 and 80.

It shall be appreciated that the control recognition unit may be either integrated on the display screen, or provided outside the display screen as a separate component.

In some embodiments, the control recognition unit is more specifically configured to acquire position coordinates of the at least two distance sensor transmitters with respect to the display screen 40 based on the ranging signals, to acquire an intersection between a straight line along which the control pen is arranged and the display screen 40 based on the position coordinates, and to determine a control point of the control pen on the display screen 40. In one example embodiment, the control point recognition unit acquires distances from the at least two distance sensor transmitters 50 and 80 to the at least three distance sensor receivers 10, 20 and 30 based on ranging signals received by the at least three distance sensor receivers 10, 20 and 30 from the at least two distance sensor transmitters 50 and 80, thereby determining coordinates of the at least two distance sensor transmitters 50 and 80 with respect to the display screen 40, and at the same time, determining the straight line along which the control pen is arranged based on a principle that two points decide a line, such as a straight-line equation of the straight line along which the control pen is arranged. The control point recognition unit can calculate an intersection between the straight line along which the control pen is arranged and the display screen 40 based on the straight-line equation of the straight line, and determine the intersection between the straight line and the display screen 40 as a control point of the control pen on the display screen.

In an example embodiment, assuming that the three distance sensor receivers 10, 20 and 30 are arranged in a plane where the display screen is located, their coordinates are known as (x₁,y₁,0), (x₂,y₂,0) and (x₃,y₃,0), respectively, and distances from the distance sensor transmitter 50 to the three distance sensor receivers 10, 20 and 30 are a, b and c, respectively, then coordinates(x, y, z) of the distance sensor transmitter 50 with respect to the display screen can be calculated through the following equations (1) to (3).

(x−x₁)²+(y−y₁)²+(z−0)²=a² (1)

(x−x₂)²+(y−y₂)²+(z−0)²=b² (2)

(x=x₃)²+(y−y₃)²+(z−0)²=c² (3)

Similarly, the coordinates of the distance sensor 80 with respect to the display screen can be calculated in the same way.

It should be noted that although in FIG. 1 the three distance sensor receivers 10, 20 and 30 are located in the same plane as the display screen 40 and provided on the edges of three corners of the display screen 40, respectively, it is not difficult for a person skilled in the art to understand that more than three distance sensor receivers may be adopted, and distances from the distance sensor transmitters to three distance sensor receivers having the strongest signal intensity can be acquired based on ranging signals received by those three distance sensor receivers from the distance sensor transmitters. In addition, it also should be appreciate that the distance sensor receivers may be arrange at fixed positions with respect to the display screen, but they are not necessary to be arranged in the same plane as the display screen 40 or around the display screen 40.

In FIG. 1, the ranging signals transmitted by the distance sensor transmitters 50 and 80 may be one or both types of infrared signal and ultrasonic signal. In some embodiments, both the distance sensor transmitters 50 and 80 may transmit infrared signals or ultrasonic signals as the ranging signals. In other embodiments, the distance sensor transmitters 50 and 80 may transmit infrared signals and ultrasonic signals as the ranging signals, respectively.

After the control point is determined, the selected content can be controlled by the control pen. During implementation of the control, the remote control device for the display screen further comprises a display screen control unit, wherein the control pen further comprises a control pen main control unit. After the control point is determined, the control pen main control unit may generate a control command signal, and the display screen control unit may receive the control command signal from the control pen main control unit in a wire or wireless manner, so as to perform an operation corresponding to the control command signal on respective content in the display screen, as illustrated in FIG. 4. In an embodiment, the touch screen control unit may also receive the control command signal from the control pen main control unit via wireless communication technologies, such as Bluetooth.

In some embodiments, the control pen may further comprise a control pen command receiving unit, such as a pressure sensor. The control pen main control unit may generate a control command signal based on a control command received by the control pen command receiving unit. In an embodiment, the pressure sensor may comprise a pressure sensor button 60, and the control pen main control unit may generate a control command signal based on a press signal received from the pressure sensor button 60. By way of example, a control command signal such as double click signal may be generated if the press signal is detected as being continuous within a period; a control command signal such as right-click menu popup signal may be generated if the press signal is detected for two or more times within a period; and a control command signal such as click signal may be generated if only one press signal is detected within a period and the duration of the press signal is lower than a threshold. It is not difficult for a person skilled in the art to understand that similar designs can be adopted, which are omitted herein.

In some embodiments, the display screen is a touch screen. In that case, a remote control operation of the touch screen can be realized through the remote control device provided by the present disclosure, and touch control operations for identical or different functions can also be realized by means of contact-type touch.

In some embodiments, the control pen is provided with a laser transmitter 110. For example, the laser transmitter 110 is provided at the pen tip of the control pen, and the control pen may be further provided with a laser transmitter switch 70 that controls On-Off of the laser transmitter 110. When the laser transmitter switch is switched on, the laser transmitter on the control pen can emit laser light. Usually, the laser spot on the display screen coincides with the control point, and may be used to indicate the position of the control point for the user. However, in some cases, the laser spot on the display screen may not coincide with the control point. A laser transmitter fine adjustment device may be provided in the control pen, for a fine adjustment of the emitting direction of the laser, so that the laser spot on the display screen coincide with the control point or, for correcting the control point according to the deviation between the laser spot on the display screen and the control point, so that the laser spot on the display screen coincides with the control point.

In some embodiments, the control pen is further provided with a control pen switch 90 that controls On-Off of the distance sensor transmitter.

As illustrated in FIG. 2, according to another example embodiment of the present disclosure, a control pen for the remote control device is provided. the control pen may comprise a laser transmitter 110 arranged at a pen tip, distance sensor transmitters 120 and 200 arranged at the pen tip and a pen tail, respectively, a signal processor 130, a pressure sensor 150, a pressure sensor button 60, a main control unit 160, a power supply 170, a laser transmitter switch 190, a control pen switch 210 and a control pen housing 180, wherein a spring 140 is provided between the pressure sensor 150 and the pressure sensor button 60. It should be noted that although the positions of the above components are relatively fixed in FIG. 2, it is not difficult for a person skilled in the art to understand that the above components may also be provided at other positions on the control pen, or provided into one module.

During the use of the control pen, in the case that the control pen switch 210 is opened, the distance sensor transmitters 120 and 200 transmit ranging signals. After the control point is determined, the control pen main control unit 160 generates a control command signal based on the press signal received by the pressure sensor 150. Finally, the generated control command signal is transmitted to the display screen control unit in wire or wireless manner. During the use, the laser transmitter switch 190 may be opened or closed upon actual demand to control whether the laser transmitter 110 emits laser light, thereby controlling whether to indicate the position of the control point. The generation and transmission of the control command signal have been described as above, and are omitted herein.

According to another example embodiment of the present disclosure, a method for remotely controlling a display screen is provided. The method comprises the steps of: receiving at least two ranging signals by providing at least three distance sensor receivers 10, 20 and 30 at fixed and different positions with respect to the display screen 40, wherein the at least two ranging signals come from at least two distance sensor transmitters 50 and 80 at positions with different distances from a pen tip on the control pen, respectively; and determining a control point of the control pen on the display screen 40 based on ranging signals received by the at least three distance sensor receivers 10, 20 and 30 from the at least two distance sensor transmitters 50 and 80.

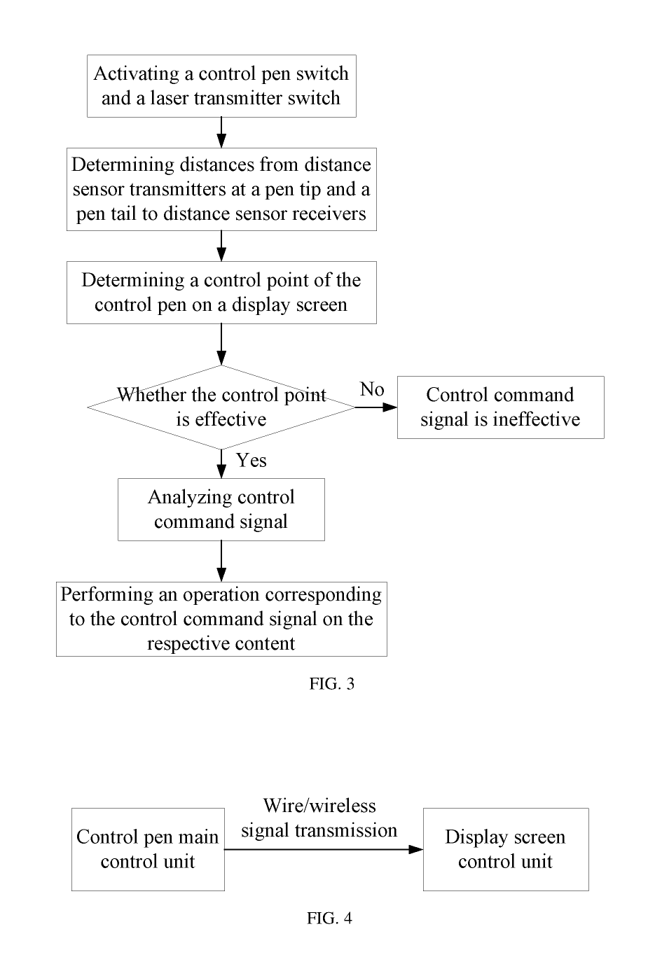

In some embodiments, as illustrated in FIG. 3, during the determination of the control point of the control pen on the display screen, firstly distances from the at least two distance sensor transmitters 50 and 80 to the at least three distance sensor receivers 10, 20 and 30 are determined, respectively; and then coordinates of the at least two distance sensor transmitters 50 and 80 with respect to the display screen 40 are determined; next, a spatial position of a straight line along which the control pen is arranged with respect to the display screen 40 is determined based on a principle that two points decide a line, finally, an intersection between the straight line along which the control pen is arranged and the display screen 40 is determined, and the intersection between the straight line along which the control pen is arranged and the display screen 40 is determined as a control point of the control pen on the display screen.

After the control point is determined, the method for remotely controlling the display screen further comprises a step of determining whether the determined control point is effective. In one embodiment, the step of determining whether the determined control point is effective specifically comprises: determining whether the determined control point locates within an effective area of the display screen; in response to that the determined control point locates within the effective area of the display screen, analyzing a control command signal received from the control pen so as to perform an operation corresponding to the control command signal on respective content in the display screen; in response to that the determined control point does not locate within the effective area of the display screen, determining that the control command signal is ineffective.

In some embodiments, the control command signal is generated based on the control command received by the control pen. For example, the control command signal is generated based on a press signal received by the control pen.

In some embodiments, during the determination of the distances from the distance sensor transmitters 50 and 80 to the distance sensor receivers 10, 20 and 30, the distance sensor transmitters 50 and 80 transmit ranging signals, such as infrared signals and ultrasonic signals, to the distance sensor receivers 10, 20 and 30.

In some embodiments, the method for remotely controlling the display screen further comprises indicating the position of the control point by the laser transmitter 110 on the control pen. Specifically, while the laser transmitter switch 190 is opened, the laser transmitter 110 on the control pen may emit laser light, and a spot formed by the laser impinging on the display screen 40 coincides with the control point to indicate the position of the control point.

The above descriptions are just specific embodiments of the present disclosure, and the protection scope of the present disclosure is not limited thereto. Any change or replacement easily conceivable to a person skilled in the art within the technical scope revealed by the present disclosure shall be covered by the protection scope of the present disclosure. Therefore, the protection scope of the present disclosure shall be determined by the protection scope of the claims.

1. A remote control device for a display screen, comprising at least three distance sensor receivers that are fixed with respect to the display screen and arranged at different positions, a control pen and a control point recognition unit, wherein the control pen is provided with at least two distance sensor transmitters at positions in different distances to a pen tip; the at least three distance sensor receivers are configured to receive ranging signals from the at least two distance sensor transmitters, respectively; the control point recognition unit is configured to determine a control point of the control pen on the display screen based on the ranging signals received by the at least three distance sensor receivers.

2. The remote control device according to claim 1, wherein the control point recognition unit is further configured to acquire position coordinates of the at least two distance sensor transmitters with respect to the display screen based on the ranging signals, acquire an intersection between a straight line along which the control pen is arranged and the display screen based on the position coordinates, and determine a control point of the control pen on the display screen.

3. The remote control device according to claim 1, wherein the ranging signal is at least one of an infrared signal and an ultrasonic signal.

4. The remote control device according to claim 1, further comprising a display screen control unit, wherein the control pen further comprises a control pen main control unit configured to generate a control command signal; the display screen control unit is configured to receive the control command signal from the control pen main control unit in a wire or wireless manner, so as to perform an operation corresponding to the control command signal on respective content in the display screen.

5. The remote control device according to claim 4, wherein the control pen further comprises a control pen command receiving unit; the control pen main control unit is further configured to generate the control command signal based on a control command received by the control pen command receiving unit.

6. The remote control device according to claim 5, wherein the control pen command receiving unit is a pressure sensor.

7. The remote control device according to claim 1, wherein the display screen is a touch screen.

8. The remote control device according to claim 1, wherein the control pen is provided with a laser transmitter configured to indicate a position of the control point.

9. The remote control device according to claim 8, wherein the control pen is further provided with a laser transmitter switch configured to control On-Off of the laser transmitter.

10. The remote control device according to claim 1, wherein the control pen is further provided with a control pen switch configured to control On-Off of the distance sensor transmitters.

11. The remote control device according to claim 1, wherein the at least three distance sensor receivers comprise three distance sensor receivers arranged at different corners of the display screen.

12. A method for remotely controlling a display screen, comprising:
receiving ranging signals from at least two distance sensor transmitters on a control pen and at positions in different distances to a pen tip, respectively, by at least three distance sensor receivers fixed with respect to the display screen and arranged at different positions; and
determining a control point of the control pen on the display screen, based on the ranging signals received by the at least three distance sensor receivers.

13. The method according to claim 12, further comprising:
determining whether the determined control point locates within an effective area of the display screen; in response to that the determined control point locates within the effective area of the display screen, determining that the determined control point is effective and analyzing a control command signal received from the control pen so as to perform an operation corresponding to the control command signal on respective content in the display screen; in response to that the determined control point does not locate within the effective area of the display screen, determining that the determined control point and the control command signal are ineffective.

14. The method according to claim 12, wherein determining the control point of the control pen on the display screen comprises: acquiring position coordinates of the at least two distance sensor transmitters with respect to the display screen, acquiring an intersection between a straight line along which the control pen is arranged and the display screen based on the position coordinates, and determining the control point of the control pen on the display screen.

15. The method according to claim 12, wherein the ranging signal is at least one of an infrared signal and an ultrasonic signal.

16. The method according to claim 12, wherein the display screen is a touch screen.

17. The method according to claim 12, further comprising indicating a position of the control point by a laser transmitter on the control pen.

18. The method according to claim 13, wherein the control command signal is generated by the control pen based on a control command received by the command receiving unit.

19. The remote control device according to claim 2, further comprising a display screen control unit, wherein the control pen further comprises a control pen main control unit configured to generate a control command signal; the display screen control unit is configured to receive the control command signal from the control pen main control unit in a wire or wireless manner, so as to perform an operation corresponding to the control command signal on respective content in the display screen.

20. The remote control device according to claim 19, wherein the control pen further comprises a control pen command receiving unit; the control pen main control unit is further configured to generate the control command signal based on a control command received by the control pen command receiving unit.
